(19) United States
(12) Patent Application Publication
(10) Pub. No.: US 2010/0139347 A1
(43) Pub. Date: Jun. 10, 2010

(54) NANO-COMPOSITE SUPERABSORBENT CONTAINING FERTILIZER NUTRIENTS USED IN AGRICULTURE

(76) Inventor: Abolfazl Barati, Arak (IR)

Correspondence Address: CHOBIN & CHOBIN CONSULTANCY L.L.C, Green Community, Building 3, Ground Floor, Dubai Investment Park, P.O Box 212880, Dubai, AE

(21) Appl. No.: 12/701,613

(22) Filed: Feb. 8, 2010

Related U.S. Application Data
(60) Provisional application No. 61/290,055, filed on Dec. 24, 2009.

(51) Int. Cl. C05F 11/00

(52) U.S. Cl. 71/23; 71/27

(57) ABSTRACT

The embodiments herein disclose a nano-composite superabsorbent polymer (NC-SAP) composition encapsulating fertilizer/plant nutrient products and a method of producing NC-SAP based products. According to one embodiment, the method involves graft polymerizing a monomer, other than acrylonitrile, onto a carbohydrate in the presence of an initiator to form a graft carbohydrate copolymer, dispersing an inorganic nano powder, adding fertilizer nutrient to the reaction mixture, cross-linking the carbohydrate graft copolymer by adding a cross-linking agent, such as methylene bis-acrylamide, adjusting the pH of the cross-linked nano-composite carbohydrate graft copolymer and isolating the nano-composite carbohydrate graft copolymer. The method also includes drying the nano-composite carbohydrate graft copolymer, to yield particles that are NC-SAP containing fertilizer. The isolation of particles of NC-SAP polymer product may occur by the methods, including, but not limited to, granularization, extrusion and pelletization.

### CROSS REFERENCE TO RELATED APPLICATIONS

This application is based on a prior provisional application Ser. No. 61/290,055, filed on Dec. 24, 2009, the benefit of the filing dates of which is hereby claimed under 35 U.S.C.sctn.119(e).

### BACKGROUND

1. Technical Field

The embodiments herein generally relates to the field of nano-composite based superabsorbent in general and in particular the embodiments relate to a composition and a method of preparing the nano-composite superabsorbent encapsulating fertilizer and plant nutrients with high fluid/water absorption and retention capacities and their agricultural application.

2. Description of the Related Art

Fertilizer and water are two important external limiting factors affecting production of agriculture. So it is very important to improve the utilization of water resources and fertilizer nutrients. The most widely used and commonly considered yield limiting plant macro nutrients are nitrogen (N), phosphorous (P) and potassium (K) or NPK fertilizers. Land managers, farmers and home owners commonly apply soluble forms of nitrogen and phosphorous as inorganic fertilizers in quantities greater than plants can assimilate, leading to leaching and often surface and ground water contamination. Transport of P from agricultural soils to surface waters has been linked to eutrophication in fresh water and estuaries. Nitrogen and P accumulation in fresh or brackish water can over stimulate the growth of algae creating conditions that interfere with the health and diversity of indigenous plant and animal population. Also, one of the most alarming problems which the three-fourth of the world is facing is nitrate leaching and subsequent pollution of ground water. The seriousness of the problem can be assessed by the fact that nitrates and nitrites are implicated in many fatal physiological disorders such as methemoglobinemia in babies, oral cancer, cancer of the colon, rectum, gastrointestinal cancers, and other health issues.

One possible way to improve nutrients use efficiently while reducing the environmental hazards is by using slow-release fertilizers. Compared to the conventional type of fertilizer application, slow release fertilizers have many advantages, such as decreasing fertilizer loss rate, supplying nutrients sustainably, lowering application frequency and minimizing potential negative effects associated with over dosage. Coated fertilizers, physically prepared by coating fertilizer granules with various materials are the major categories of the slow-release fertilizers. But this type of slow-release fertilizers depends on the soil moisture. Superabsorbent polymers (SAPs) are materials that have the ability to absorb and retain large volumes of water and aqueous solutions. Over the last five decades, SAPs has received particular attention as promising material for a series of applications in which the efficient use of water is required, for example; soil conditioning.

Combining superabsorbent with fertilizer obtains both slow release and water retention properties. In general, combining fertilizers with superabsorbents is done by two methods. In the first method, fertilizers are blended with superabsorbents. In the second method, fertilizers are added to the reaction mixture and polymerized in situ whereby the fertilizers are entrapped in the superabsorbents. These two methods always lead to a “burst effect” and higher release rate. To overcome this, a new combining method is required and the present invention discloses one such cost effective method to prevent the burst effect and decreases the release rate of fertilizer.

### SUMMARY

The primary objective of the embodiments herein is to provide a superabsorbent nano-composite encapsulating fertilizer and important plant nutrient for agricultural application without causing or limiting environmental hazard.

Another objective of the embodiments herein is to provide the method of preparing the superabsorbent nano-composite encapsulating fertilizer which is capable of slow release/controlled release of a plant nutrient.

Yet another objective of the embodiments herein is to provide a nano-composite superabsorbent encapsulating fertilizers; wherein the superabsorbent is a resin based polymer which has very high liquid/water absorption and retention capacity under pressure.

Further objective of the embodiments herein is to provide a superabsorbent nano-composite based composition encapsulating nitrogen, phosphorous and potassium or NPK fertilizer compounds to provide an economical and readily available source imminently suitable for correcting NPK deficiencies in plant life growing at such sites.

The embodiments herein discloses a nano-composite superabsorbent polymer (NC-SAP) composition encapsulating fertilizer/plant nutrient products for use in agricultural applications and a method of producing NC-SAP based products and their use. Certain methods of producing NC-SAP products disclosed do not require the use of acrylonitrile as a monomer and does not require the step of saponification.

According to one embodiment, the method involves graft polymerizing a monomer, other than acrylonitrile, onto a carbohydrate in the presence of an initiator to form a graft carbohydrate copolymer; dispersing an inorganic nano powder in a solution including the graft carbohydrate copolymer to obtain a reaction mixture; adding a fertilizer nutrient to the reaction mixture; cross-linking the carbohydrate graft copolymer, for example, by adding a cross-linking agent, such as methylene bis-acrylamide; and isolating the nano-composite carbohydrate graft copolymer. The disclosed method may also include adjusting the pH of the cross-linked nano-composite carbohydrate graft copolymer. Moreover, the method may further include drying the nano-composite carbohydrate graft copolymer, to yield particles that are nano-composite superabsorbent containing fertilizer. The isolation of the particles of nano-composite superabsorbent polymer product may occur by various methods, including, but not limited to, granularization, extrusion, and pelletization.

The above and other objects, features and advantages of the embodiments herein will become apparent from the following description read in conjunction with the accompanying figures. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a process flow chart indicating the different steps involved in the preparation method of nano-composite based

FIG. 2 is a scanning electron microscope (SEM) photograph of a) clinoptilolite nano powders and b) NC-SAP.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in the specification to “one embodiment”, “in one embodiment” or “an embodiment” etc. means that a particular feature, structure, characteristic, or function described in connection with the embodiment is included in at least one embodiment herein. The appearances of the phrase “in one embodiment” in various places in the specification are not necessarily all referring to the same embodiment.

The embodiments herein relates to a relatively inexpensive absorbent resin composition and a process for producing the same. The absorbent resin composition of the embodiments herein, upon contact with aqueous fluids, absorbs the aqueous fluid to a high degree and maintains great fluid retention even under pressure. The embodiments herein discloses a nano-composite superabsorbent adapted to encapsulate, isolate, or otherwise contain nitrogen, phosphorous and potassium (NPK) inorganic fertilizer to provide an economical and readily available source imminently suitable for correcting NPK deficiencies in plant life growing in soils deficient in such nutrients. The nano-composite superabsorbent can also encapsulate other nutrients which are required for the plant growth and its productivity.

One of the embodiment discloses how a combination of polymers and NPK fertilizer could be band applied at or prior to planting or spot placed in the root zone of growing plants in soil to minimize the contact of these products with the soil so that chemical reactions which adversely affect the availability of this products to plants are minimized and also reduce/minimize the soil and ground water pollution.

According to the embodiments herein, the term plant nutrient means mineral nutrients which include the broad class of macronutrient and micronutrient. The macronutrient further includes primary nutrient such as nitrogen (N), phosphorous (P) and potassium (K) and secondary nutrients such as Calcium (Ca), Magnesium (Mg) and sulfur (S). While micronutrients includes boron (B), copper (Cu), iron (Fe), chloride (Cl), Manganese (Mn), Molybdenum (Mo) and Zinc (Zn).

### Method of Preparing the Nano-Composite Polymer Encapsulating the Plant Nutrients

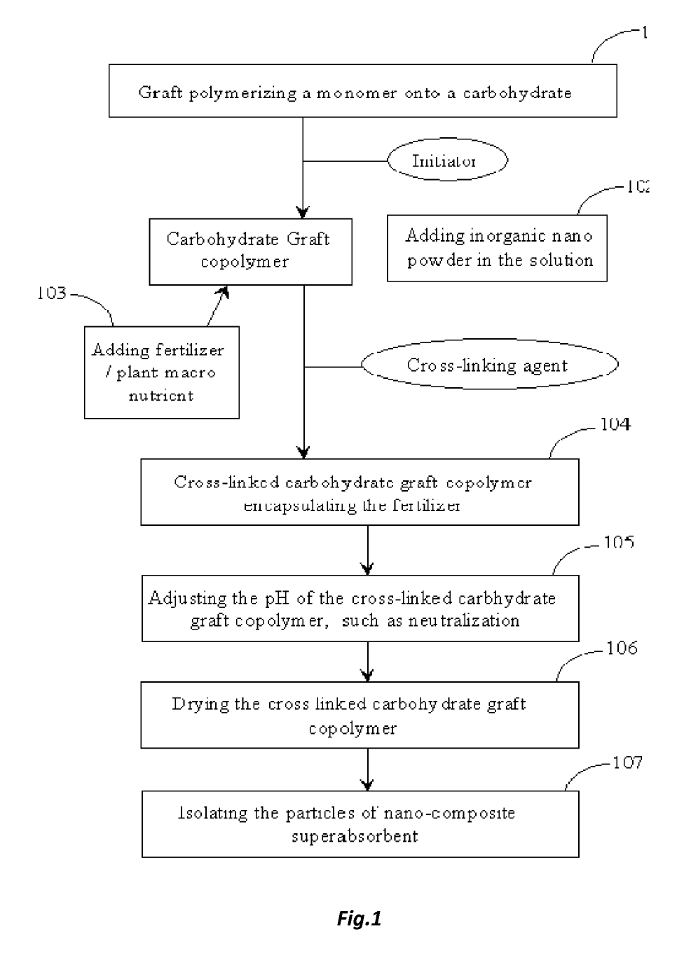

With respect to FIG. 1, The method of preparing the nano-composite superabsorbent polymer (NC-SAP) containing fertilizer of the present invention in large-scale for agricultural applications comprises graft polymerizing a monomer onto a carbohydrate in the presence of an initiator to form a carbohydrate graft copolymer (101); dispersing an inorganic nano powder in a solution including the carbohydrate graft copolymer to form a reaction mixture (102); adding a fertilizer/plant macro nutrient to the reaction mixture (103); cross-linking the nano-composite carbohydrate graft copolymer, by adding a cross-linking agent, such as methylene bis-acrylamide to crosslink the carbohydrate graft copolymer (104); adjusting the pH of the cross-linked carbohydrate graft copolymer, such as neutralization (105); drying the cross linked carbohydrate graft copolymer (106); and isolating the particles of nano-composite superabsorbent using granularization, extrusion, and pelletization (107).

Polymerization of the comonomer having the superabsorbent properties in the embodiments herein can be carried out by known methods in art but not limited to bulk polymerization, solution polymerization, spray polymerization, inverse emulsion polymerization, and suspensions polymerization/inverse suspension polymerization. According to the embodiments herein, preferably, a solution polymerization is performed using water as solvent. The solution polymerization may be conducted in a continuous or batch wise fashion. The patent literature includes a broad spectrum of possible variations with respect to concentration conditions, temperatures, type and amount of initiators and of secondary catalysts. Typical processes have been described in the following patent specifications: U.S. Pat. No. 4,076,663; U.S. Pat. No. 4,286,082; U.S. Pat. No. 7,009,020; and U.S. Pat. No. 7,591,974. These disclosures are hereby incorporated as reference.

The superabsorbent polymer of the nano-composite has one or more unsaturated carboxylic acid monomer, or its salts thereof. The unsaturated acid group-containing monomers to be used according to the invention includes but not limited to acrylic acid, methacrylic acid, crotonic acid, isocrotonic acid, maleic acid, fumaric acid, itaconic acid, vinyl acetic acid etc while the preferred unsaturated carboxylic acid monomer is an acrylic acid and its alkali and/or ammonium salts and mixtures thereof.

The example for sulfonic acid monomer includes 2-acrylamido-2-methyl-1-propanesulfonic acid (AMPS), methallyl sulfonic acid, and vinyl sulfonic acid; as well as the alkali and/or ammonium salts thereof.

The monomer can also be one or more amides such as acrylamide or methacrylamide. Still further it can be, acrylates, such as ethyl acrylate and potassium acrylate may also be used. Derivatives and mixtures of the above-listed monomers may also be desirable. Additionally, the polymer may include co-monomers known in the art. Furthermore, it is also possible that the monomers used are hydrolyzed to form acid groups as late as subsequent to the polymerization as is possible.

The acidic monomers preferably are subjected to neutralization. The neutralization can be performed in various ways. According to U.S. Pat. No. 4,654,039, the polymerization may be conducted directly with the acidic monomers, with neutralization being effected subsequently in the polymer gel. On the other hand and preferably, the acidic monomer components are neutralized to 20-95%, preferably 50-80% prior to polymerization, in which case they are present as sodium and/or potassium and/or ammonium salts at the beginning of polymerization. It is preferred to use those bases for neutralization which do not adversely affect the subsequent polymerization. In the present invention, it is preferred to use sodium or potassium hydroxide solution and/or ammonia, with potassium hydroxide solution being particularly preferred base.

Before initiating the polymerization in this adiabatic solution, the partially neutralized monomer solution is cooled to a temperature of below 30° C., preferably below 20° C. In the other processes mentioned, other temperatures are also well-known and conventional according to the state of the art.

In order to modify the polymer properties, up to 30 wt. % of other co-monomers soluble in the aqueous polymerization batch; such as acrylamide, methacrylamide, (meth)allyl alcohol ethoxylates, and mono(meth)acrylic acid esters of alcohols or ethoxylates can optionally be used.

In an alternative method, in one of the embodiments herein, partially hydrolyzed acrylic acid may be graft polymerized onto a carbohydrate or any other polysaccharide without the assistance of acrylamide. For example, partially hydrolyzed acrylic acid may be polymerized when placed under heat and/or pressure.

Polymerization without the addition of acrylamide may be accomplished, for example, in a heated screw extruder, such as a single screw or a double screw.

The carbohydrate used in the embodiments herein is selected from the following group of polysaccharide but not limited to starch, cellulose, flours, meals, carbohydrate waste and crop residues. More specifically, the starches include native starches (e.g., corn starch, waxy maize starch, wheat starch, potato starch, dextrin starches, and dextran starches), corn meal, wheat flour, rice flour, wheat straw, rice straw, corn straw and germinated waste carbohydrate. The carbohydrate may be gelatinized to provide optimal absorbency. An exemplary gelatinized carbohydrate is wheat and rice straw.

Furthermore, according to one embodiment, the weight ratio of the crop residue (wheat or rice straw) to the monomer is in the range of about 1:1 to about 1:8.

In one embodiment, the SAP encapsulating the nutrient is modified to provide a controlled release of the encapsulated fertilizer/plant nutrients. In order to prevent burst effect and to decrease the release rate of encapsulated nutrient, the properties of SAPs is modified using an inorganic nano powder.

The nano-composite superabsorbent polymer containing fertilizer according to the present invention may further contain substances other than monomers and carbohydrates. These additional substances may be multivalent metal and hydrophilic inorganic powder to improve/alter the liquid absorption-retention and also the slow release properties of SAP.

Specifically, the included inorganic powders are substances which are inert in aqueous liquid, such as, various inorganic compound fine particles, clay mineral fine particles etc. Preferable the inorganic powder included in the embodiments herein has an appropriate hydrophilic property and it is insoluble or hardly soluble in water. Specific examples of the inorganic powder included are metal oxides, such as silicon dioxide and titanium oxides; silicic acids (salts), natural zeolite and synthetic zeolite, kaolin, talc; clays and bentonite. Preferably natural zeolite and synthetic zeolite. More preferably natural zeolite includes Clinoptilolite, Faujasite, Erionite, etc and synthetic zeolite (NaA, Y, T, ZSM-5, MCM-41, SAPO-34, etc) having an average particle diameter of 100 nm or less as measured using a particle size analyzer. Using nano-clinoptilolite and nano sized synthetic NaA-type zeolite powder in SAP was found to be more effective in providing a more controlled/slow releasing effect.

During the process of producing the nano-composite superabsorbent polymer, various additives may optionally be included at different stages during the production of the NC-SAP product. For example, additives to promote plant growth may be included at some stage of the SAP production process, such as during polymerization or previous to drying step, as would be apparent to those skilled in the art with the aid of the present disclosure. One exemplary additive includes fertilizer. Various fertilizers that are commercially available may be included. Exemplary soil-based nutrients that may also optionally be added during or after production of the NC-SAP product include micro plant nutrient such as calcium, magnesium, potassium, phosphorus, boron, zinc, manganese, copper, iron, sulfur, nitrogen, molybdenum, silicon, ammonium phosphate, fish meal, organic compounds and additives, organic based fertilizers derived from plant and animal products and derivatives, blends, and mixtures thereof. More information about exemplary growth-promoting additives can be found in The Farm Chemicals Handbook published by Meister Publishing Company.

Minor amounts of cross linking monomers having more than one reactive group in their molecules are co-polymerized together with the above-mentioned monomers, thereby forming partially cross linked polymer products which are no longer soluble in water but merely swellable. Bi- or multifunctional monomers includes, e.g. amides such as methylene-bis-acryl or methacrylamide, or ethylene-bis-acrylamide may be mentioned as cross linking monomers, and also, allyl compounds such as allyl (meth)acrylate, triallyl cyanurate, maleic acid diallyl ester, polyallyl esters, tetraallyloxyethane, triallylamine, tetraallylethylenediamine, allyl esters of phosphoric acid or phosphorous acid, and also, cross linkable monomers such as N-methylol compounds of unsaturated amides like methacrylamide or acryl amide and the ethers derived there from, as well as esters of polyols and alkoxylated polyols, such as diacrylates or triacrylates, e.g. butanediol or ethylene glycol diacrylate, polyglycol di(meth)acrylates, trimethylolpropane triacrylate, methacrylate esters of glycerol and pentaerythritol, and of glycerol. It is preferred to use amides, triallylamine, acrylates of polyhydric alcohols or alkoxylates thereof, and methallyl alcohol acrylates or alkoxylates thereof.

The ratio of cross linking monomers is from 0.01 to 4.0 wt. %, preferably from 0.04 to 2.5 wt. %, and more preferably from 0.05 to 1.5 wt. %, relative to the total monomers.

The monomer may be graft polymerized onto a carbohydrate in the presence of an initiator. Exemplary initiators for use in the above-described method include: ammonium persulfate; sodium persulfate; potassium persulfate; ferrous peroxide; hydrogen peroxide; L-ascorbic acid; and potassium permanganate-ascorbic acid. Other suitable initiators known to those skilled in the art may be used, such as alternative persulfates and peroxides. The amount of initiator used may vary based on the chosen initiator, the selected monomer, and the chosen carbohydrate. Some initiators, e.g., persulfates, may require the presence of heat. The initiator may be added in a single or multiple steps, and multiple initiators may be used.

Once a cross-linked nano-composite carbohydrate graft copolymer is formed, the pH of the cross-linked nano-composite carbohydrate graft copolymer may be adjusted to a desired value for the particular agricultural application. For example, the cross-linked nano-composite carbohydrate graft copolymer may be neutralized to convert the carboxyl groups to potassium salts. Alternative pH values may be desirable depending upon the type of soil and the type of crop where the resulting NC-SAP encapsulating nutrient will be applied. The resulting pH for most agricultural applications typically will range from about 6.0 to about 8.0. The desired pH may be greater or less than this range depending on the requirements for the particular agricultural application.

Alternatively, in some embodiments, the pH adjustment of the nano-composite carbohydrate graft copolymer may occur prior to cross-linking. In contrast to some alternative methods which require saponification, the step of pH adjustment/neutralization may be significantly faster, easier, and less expensive compared to saponification. Furthermore, adjusting the pH does not necessarily produce corrosive and dangerous reaction by-products such as ammonia. Exemplary solvents that may be used to effect pH adjustment include but not limited to potassium hydroxide, potassium methoxide, or a mixture thereof, any of which may optionally be diluted in methanol or other solvents.

In alternative embodiments, pH adjustment may not be necessary. For instance, if potassium acrylate were used as the monomer in lieu of acrylic acid, the resulting product may already be within an acceptable pH range.

In one embodiment, the resulting pH adjusted, cross-linked nano-composite carbohydrate graft copolymer may then be isolated. One exemplary method of isolation involves simply drying the cross-linked nano-composite carbohydrate graft copolymer, such as, for example, on a heated drum or via air-drying. The dried NC-SAP product may then be pelletized according to pelletization methods known to those having skill in the art.

### Isolation of the Nano-Composite Superabsorbent Polymer Encapsulating Nutrients

In another embodiment, the step of isolating the nano-composite carbohydrate graft copolymer involves extruding the cross-linked nano-composite carbohydrate graft copolymer such as through a heated screw to form granules of NC-SAP product. To minimize re-agglomeration of the granules, the granules may be coated with a dusting agent that decreases their propensity to stick together. Exemplary dusting agents include but not limited to cellulose, clay, starch, flour, carbohydrate waste, crop residue and other natural or synthetic polymers that prevent the granules from sticking together. Alternatively, the granules may be lightly sprayed with methanol to prevent them from sticking together, and the extrusion can be performed under high pressure.

Yet another exemplary method of isolating the nano-composite carbohydrate graft copolymer involves precipitating the pH-adjusted, cross-linked nano-composite carbohydrate graft copolymer using water-miscible solvents such as alcohols, e.g., methanol, ethanol, propanol, isopropanol and glycol. Immersing the cross-linked nano-composite carbohydrate graft copolymer in alcohol may cause the alkali nano-composite carbohydrate graft copolymer to precipitate into particles that are later screened to the desired size after drying. The alcohol removes the water and extraneous salts from the cross-linked starch graft copolymer.

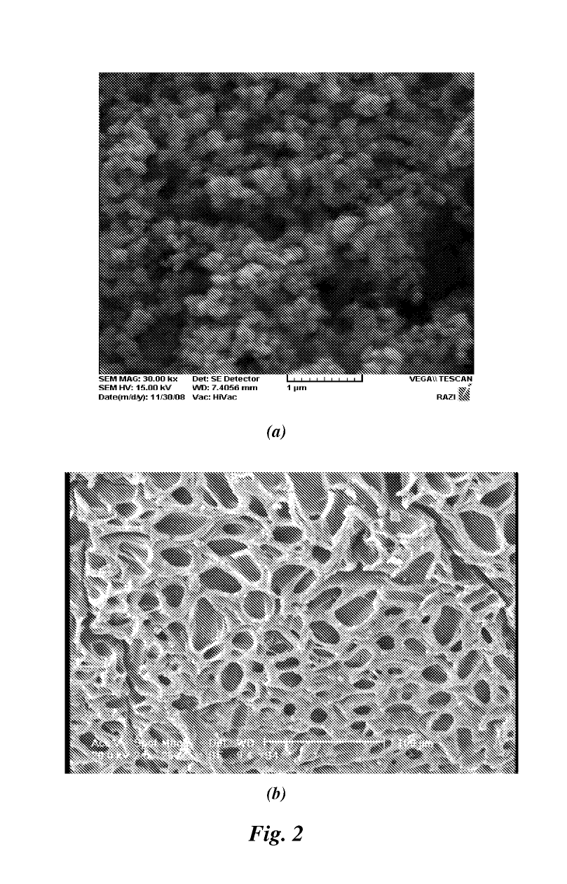

FIG. 2 shows the scanning electron microscope (SEM) photograph of a) clinoptilolite nano powders and b) NC-SAP.

In one embodiment for agricultural applications that deposit the NC-SAP into the soil, the particle size may be less than 30 mesh, more particularly between about 10 mesh and 30 mesh, or between about 10 mesh and 20 mesh. Other agricultural applications, such as seed coating and root dipping, may use a finer particle size. For seed coating, the desired particle size may be between about 75 meshes and about 300 mesh, such as about 200 mesh. For root dipping, the desired particle size may be between about 30 mesh and about 100 mesh, such as about 50 mesh.

Alternatively, the cross-linked nano-composite carbohydrate graft copolymer product may be mixed with a solvent, such as water, to form slurry. The resulting slurry may be applied to an agricultural medium such as a plant, root, seed, seedling, or directly to soil into which one of a plant, root, seed, or seedling will be planted.

One exemplary method by which the desired size particles may be formed, the cross-linked nano-composite carbohydrate graft copolymer may be ground to a fine powder and then formed into pellets of the desired size. Pelletizing is common in the polymer industry and is known to those of skill in the art. As described above, the resulting pellets may be lightly coated with a dusting agent that decreases their propensity to stick together and reduces their tackiness.

### Agricultural Application:

The agricultural application of NC-SAPs containing fertilizer made by the above-described methods may result in earlier seed germination and/or blooming, decreased irrigation requirements, increased propagation, increased crop growth, increased crop production, reduced leaching into ground water and decreased soil crusting. Thus NC-SAPs made by the methods disclosed herein are inexpensive and desirable for forming and using a SAP in large-scale agricultural applications.

In another embodiment, different methods of using the nano-composite are disclosed to increase an agriculture/crop productivity by 1) applying the NC-SAP encapsulating nutrients directly to the soil; 2) coating a root or seed with the NC-SAP encapsulating nutrients; and 3) Forming slurry of NC-SAP encapsulating nutrients and water (or another liquid) and applying the resulting slurry to a plant, root, seed, seedling, or directly to soil into which one of a plant, root, seed, or seedling will be planted. Referring to FIG. 2, SEM images of cross-sections through the particle, the body defines pores which provide metering of fertilizer agent release, as well as compressibility and other properties.

Present invention is further illustrated by following examples but not limited to these.

### EXAMPLES

### Example 1

### This Example Illustrates the Production of a Polymer Gel Having Superabsorbent Properties

A uniform suspension of 395 ml of deionizer water and 60 g of wheat straw (200 mesh) was prepared in a 1.5 liter resin kettle using mechanical stirrer at 250 rpm. The suspension was then heated to/between about 85° C. and about 95° C. using an oil bath. The suspension was maintained at this temperature for approximately 30 minutes, at which time the oil bath was turned off and the suspension was allowed to cool to 60° C. and purged with nitrogen.

A solution of 110 ml of acrylic acid and 85 ml of deionized water was prepared in a 500 ml beaker. Using 70 ml of 50% potassium hydroxide solution, partial neutralization (degree of neutralization: 80%) was effected with stirring and cooling. The solution was cooled to 22-18° C. Thereafter, the solution of neutralized acrylic acid was added to the described suspension and resulting mixture was stirred for approximately five minutes. Then a fertilizer such as, ammonium nitrate (60 g dissolved in 60 ml of deionized water) was added to the suspension and the resulting mixture was stirred for approximately five minutes. Then methylene bis-acrylamide (3 g dissolved in 60 ml of deionized water) was added to the suspension, and the resulting mixture was stirred for approximately five minutes. Lastly, ammonium persulfate (3 g dissolved in 10 ml of deionized water) was added to the suspension and the resulting suspension was stirred while being heated to approximately 80° C. The suspension was held at that temperature and stirred for approximately 15 minutes. The resulting cross-linked composite SAP containing product was dried in a tunnel dryer so that a composite, granular SAP containing fertilizer product having a density of 1.05 grams per milliliter, and a moisture content of 10% was formed. The composite SAP containing fertilizer product exhibited the ability to imbibe or absorb between about 200 and about 250 times its weight in deionized water and to retain the imbibed or absorbed aqueous fluid under moderate pressure. Release rate of fertilizer from the composite SAP containing fertilizer product was measured in extracted solution of soil and was shown in Table 1.

### Example 2

A uniform suspension of 395 ml of deionized water and 60 g of wheat starch was prepared in a 1.5 liter resin kettle using mechanical stirrer at 250 rpm. The suspension was then heated to/between about 85° C. and about 95° C. using an oil bath. The suspension was maintained at this temperature for approximately 30 minutes, at which time the oil bath was turned off and the suspension was allowed to cool to 60° C. and purged with nitrogen.

A solution of 110 ml of acrylic acid and 85 ml of deionized water was prepared in a 500 ml beaker. Using 70 ml of 50% potassium hydroxide solution, partial neutralization (degree of neutralization: 80%) was effected with stirring and cooling. The solution was cooled to 22-18° C. Thereafter, the solution of neutralized acrylic acid was added to the described suspension and resulting mixture was stirred for approximately five minutes. Then a fertilizer such as, potassium sulfate (60 g dissolved in 60 ml of deionized water) was added to the suspension and the resulting mixture was stirred for approximately five minutes. Then methylene bis-acrylamide (3 g dissolved in 60 ml of deionized water) was added to the suspension, and the resulting mixture was stirred for approximately five minutes. Lastly, ammonium persulfate (3 g dissolved in 10 ml of deionized water) was added to the suspension and the resulting suspension was stirred while being heated to approximately 80° C. The suspension was held at that temperature and stirred for approximately 15 minutes. The resulting cross-linked composite SAP containing product was dried in a tunnel dryer so that a composite, granular SAP containing fertilizer product having a density of 1.02 grams per milliliter, and a moisture content of 10% was formed. The composite SAP containing fertilizer product exhibited the ability to imbibe or absorb between about 220 and about 280 times its weight in deionized water and to retain the imbibed or absorbed aqueous fluid under moderate pressure. The release rate of fertilizer from the composite SAP containing fertilizer product was measured in extracted solution of soil and was shown in Table 1.

### Example 3

A uniform suspension of 395 ml of deionized water and 60 g of carbohydrate waste (wasted wheat starch) was prepared in a 1.5 liter resin kettle using mechanical stirrer at 250 rpm. The suspension was then heated to/between about 85° C. and about 95° C. using an oil bath. The suspension was maintained at this temperature for approximately 30 minutes, at which time the oil bath was turned off and the suspension was allowed to cool to 60° C. and purged with nitrogen.

A solution of 110 ml of acrylic acid and 85 ml of deionized water was prepared in a 500 ml beaker. Using 70 ml of 50% potassium hydroxide solution, partial neutralization (degree of neutralization: 80%) was effected with stirring and cooling. The solution was cooled to 22-18° C. Thereafter, the solution of neutralized acrylic acid was added to the described suspension and resulting mixture was stirred for approximately five minutes. Then a fertilizer such as, ammonium phosphate (60 g dissolved in 60 ml of deionized water) was added to the suspension and the resulting mixture was stirred for approximately five minutes. Then methylene bis-acrylamide (3 g dissolved in 60 ml of deionized water) was added to the suspension, and the resulting mixture was stirred for approximately five minutes. Lastly, ammonium persulfate (3 g dissolved in 10 ml of deionized water) was added to the suspension and the resulting suspension was stirred while being heated to approximately 80° C. The suspension was held at that temperature and stirred for approximately 15 minutes. The resulting cross-linked composite SAP containing product was dried in a tunnel dryer so that a composite, granular SAP containing fertilizer product having a density of 1.1 grams per milliliter, and a moisture content of 10% was formed. The composite SAP containing fertilizer product exhibited the ability to imbibe or absorb between about 250 and about 280 times its weight in deionized water and to retain the imbibed or absorbed aqueous fluid under moderate pressure. Release rate of fertilizer from the composite SAP containing fertilizer product was measured in extracted solution of soil and was shown in Table 1.

### Example 4

A uniform suspension of 395 ml of deionized water and 60 g of wheat straw was prepared in a 1.5 liter resin kettle using mechanical stirrer at 250 rpm. The suspension was then heated to between about 85° C. and about 95° C. using an oil bath. The suspension was maintained at this temperature for approximately 30 minutes, at which time the oil bath was turned off and the suspension was allowed to cool to 60° C. and purged with nitrogen.

A solution of 110 ml of acrylic acid and 85 ml of deionized water was prepared in a 500 ml beaker. Using 70 ml of 50% potassium hydroxide solution, partial neutralization (degree of neutralization: 80%) was effected with stirring and cooling. The solution was cooled to 22-18° C. Thereafter, the solution of neutralized acrylic acid was added to the described suspension and resulting mixture was stirred for approximately five minutes. Then suspension of fertilizers such as, ammonium nitrate plus zinc sulfate (60 g dissolved in 60 ml of deionized water) and 10 g of nano-sized natural zeolite such as clinoptilolite, was added to the suspension and the resulting mixture was stirred for approximately five minutes. Then methylene bis-acrylamide (3 g dissolved in 60 ml of deionized water) was added to the suspension, and the resulting mixture was stirred for approximately five minutes. Lastly, ammonium persulfate (3 g dissolved in 10 ml of deionized water) was added to the suspension and the resulting suspension was stirred while being heated to approximately 80° C. The suspension was held at that temperature and stirred for approximately 15 minutes. The resulting cross-linked NC-SAP containing product was dried in a tunnel dryer so that a granular NC-SAP containing fertilizer product having a density of 1.13 grams per milliliter and a moisture content of 8% was formed. The NC-SAP containing fertilizer product exhibited the ability to imbibe or absorb between about 350 and about 410 times its weight in deionized water and to retain the imbibed or absorbed aqueous fluid under moderate pressure. Release rate of fertilizer from the composite SAP containing fertilizer product was measured in extracted solution of soil and was shown in Table 1.

### Example 5

A uniform suspension of 395 ml of deionized water and 60 g of wheat straw was prepared in a 1.5 liter resin kettle using mechanical stirrer at 250 rpm. The suspension was then heated to between about 85° C. and about 95° C. using an oil bath. The suspension was maintained at this temperature for approximately 30 minutes, at which time the oil bath was turned off and the suspension was allowed to cool to 60° C. and purged with nitrogen.

A solution of 110 ml of acrylic acid and 85 ml of deionized water was prepared in a 500 ml beaker. Using 70 ml of 50% potassium hydroxide solution, partial neutralization (degree of neutralization: 80%) was effected with stirring and cooling. The solution was cooled to 18-22° C. Thereafter, the solution of neutralized acrylic acid was added to the described suspension and resulting mixture was stirred for approximately five minutes. Then suspension of fertilizers such as, ammonium nitrate plus zinc sulfate (60 g dissolved in 60 ml of deionized water) and 10 g of nano-sized synthetic zeolite such as NaA, was added to the suspension and the resulting mixture was stirred for approximately five minutes. Then methylene bis-acrylamide (3 g dissolved in 60 ml of deionized water) was added to the suspension, and the resulting mixture was stirred for approximately five minutes. Lastly, ammonium persulfate (3 g dissolved in 10 ml of deionized water) was added to the suspension and the resulting suspension was stirred while being heated to approximately 80° C. The suspension was held at that temperature and stirred for approximately 15 minutes. The resulting cross-linked NC-SAP containing fertilizer product was dried in a tunnel dryer so that a granular NC-SAP containing fertilizer product having a density of 1.13 grams per milliliter, and a moisture content of 8% was formed. The NC-SAP containing fertilizer product exhibited the ability to imbibe or absorb between about 320 and about 350 times its weight in deionized water and to retain the imbibed or absorbed aqueous fluid under moderate pressure. Release rate of fertilizer from the composite SAP containing fertilizer product was measured in extracted solution of soil and was shown in Table 1.

### Example 6

A uniform suspension of 395 ml of deionized water and 60 g of wheat straw was prepared in a 1.5 liter resin kettle using mechanical stirrer at 250 rpm. The suspension was then heated to between about 85° C. and about 95° C. using an oil bath. The suspension was maintained at this temperature for approximately 30 minutes, at which time the oil bath was turned off and the suspension was allowed to cool to 60° C. and purged with nitrogen.

A solution of 110 ml of acrylic acid and 85 ml of deionized water was prepared in a 500 ml beaker. Using 70 ml of 50% potassium hydroxide solution, partial neutralization (degree of neutralization: 80%) was effected with stirring and cooling. The solution was cooled to 18-22° C. Thereafter, the solution of neutralized acrylic acid was added to the described suspension and resulting mixture was stirred for approximately five minutes. Then suspension of a fertilizer such as, urea (60 g dissolved in 60 ml of deionized water) and 10 g of nano-sized natural zeolite such as clinoptilolite was added to the suspension and the resulting mixture was stirred for approximately five minutes. Then methylene bis-acrylamide (3 g dissolved in 60 ml of deionized water) was added to the suspension, and the resulting mixture was stirred for approximately five minutes. Lastly, ammonium persulfate (3 g dissolved in 10 ml of deionized water) was added to the suspension and the resulting suspension was stirred while being heated to approximately 80° C. The suspension was held at that temperature and stirred for approximately 15 minutes. The resulting cross-linked NC-SAP containing product was dried in a tunnel dryer so that a granular NC-SAP containing fertilizer product having a density of 1.13 grams per milliliter, and a moisture content of 8% was formed. The NC-SAP containing fertilizer product exhibited the ability to imbibe or absorb between about 340 and about 395 times its weight in deionized water and to retain the imbibed or absorbed aqueous fluid under moderate pressure. Release rate of fertilizer from the composite SAP containing fertilizer product was measured in extracted solution of soil and was shown in Table 1.

TABLE 1

| Type of | Type of | Free | | | | | |
|---|---|---|---|---|---|---|---|
| superabsorbent | fertilizer | equilibrium | Release rate of fertilizer (%) | | | | |
| composite | added | swelling (g/g) | 1 hr | 24 hr | 72 hr | 144 hr | 240 hr |
| SAP + Wheat | Ammonium | 225 ± 25 | 10.00 | 60.85 | 70.12 | 81.56 | 86.30 |
| straw | nitrate | | | | | | |
| SAP + Wheat | Potassium | 250 ± 30 | 12.00 | 63.87 | 73.92 | 84.65 | 89.20 |
| starch | sulfate | | | | | | |
| SAP + Wasted | Ammonium | 265 ± 15 | 18.00 | 74.10 | 83.65 | 95.90 | 99.90 |
| wheat straw | phosphate | | | | | | |
| SAP + Wheat | Ammonium | 380 ± 30 | 3.00 | 30.80 | 44.50 | 53.00 | 56.85 |
| straw + Nano- | nitrate + | | | | | | |
| sized Clinoptilolite | Zinc sulfate | | | | | | |
| SAP + Wheat | Ammonium | 335 ± 15 | 5.00 | 39.20 | 50.56 | 57.50 | 60.95 |
| straw + Nano- | nitrate + | | | | | | |
| sized NaA zeolite | Zinc sulfate | | | | | | |
| SAP + Wheat | Urea | 360 ± 25 | 3.66 | 37.58 | 53.40 | 63.60 | 68.22 |
| straw + Nano- | | | | | | | |
| sized Clinoptilolite | | | | | | | |

Those skilled in the art will recognize that the methods and compositions disclosed herein may be practiced without one or more of the specific details described, or with other methods, components, materials, etc. In some cases, well-known materials, components or method steps are not shown or described in detail. Furthermore, the described method steps, compositions, etc., may be combined in any suitable manner in one or more embodiments. It will also be readily understood that the methods and compositions of the embodiments as generally described herein could be arranged and designed in a wide variety of different configurations.

The order of the steps or actions of the methods described in connection with the embodiments disclosed may be changed as would be apparent to those skilled in the art. Thus, any order in the detailed description is for illustrative purposes only and is not meant to imply a required order.

Having described preferred embodiments of the invention it is to be understood that the invention is not limited to the precise embodiments, and that various changes and modifications may be effected therein by those skilled in the art within the scope of the embodiments.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for preparing a nano-composite superabsorbent polymer (NC-SAP) containing fertilizer nutrient, the method comprising:
graft polymerizing a monomer onto a carbohydrate in the presence of an initiator to form a carbohydrate graft copolymer;
dispersing a nano-sized inorganic powder in a solution comprising the carbohydrate graft copolymer to form a reaction mixture;
adding a fertilizer nutrient to the reaction mixture;
adding a cross-linking agent to cross-link the carbohydrate graft copolymer;
adjusting the pH of the cross-linked nano-composite carbohydrate graft copolymer;
isolating the pH adjusted cross linked carbohydrate graft copolymer to achieve a dried bulk composite; and
forming granules or pellets of the nano-composite carbohydrate graft copolymer from the dried bulk composite.

2. The method according to claim 1, wherein the monomer is selected from a group comprising acrylic acid, acrylamide, methacrylamide, 2-acrylamido-2-methyl-propanesulfonic acid, methacrylic acid, vinyl sulfonic acid, ethyl acrylate, potassium acrylate and derivatives thereof or mixtures thereof.

3. The method according to claim 1, wherein said monomer is a mixture of acrylic acid and acrylamide.

4. The method according to claim 1, wherein said carbohydrate is a mixture of carbohydrate waste and crop residue (wheat or rice straw).

5. The method according to claim 1 wherein a weight ratio of said crop residue (wheat or rice straw) to said monomer is in the range of 1:1-1:8.

6. The method according to claim 1 wherein the initiator is selected from a group comprising azobisisobutyronitrile, sodium peroxodisulfate, t-butyl hydroperoxide, or dibenzoyl peroxide, sodium hydrogen sulfite with potassium persulfate and ascorbic acid with hydrogen peroxide.

7. The method according to claim 1, wherein the inorganic powder is selected from a group comprising Faujasite, Erionite and clinoptilolite.

8. The method according to claim 1, wherein the inorganic powder is clinoptilolite.

9. The method according to claim 1, wherein the cross-linking agent is selected from a group comprising amides, triallylamines, acrylates of polyhydric alcohols or alkoxylates thereof and methallyl alcohol acrylates or alkoxylates thereof.

10. The method according to claim 1, wherein the cross linking agent is added to the in a given ratio.

11. The method according to claim 1, wherein the ratio of said cross linking monomers to the nano composite carbohydrate graft copolymer is 0.01 to 4.0 wt. %, preferably about 0.04 to 2.5 wt. %, and more preferably about 0.05 to 1.5 wt. %.

12. The method according to claim 1, wherein the pH is adjusted to within a range of about 6.0 to about 8.0.

13. The method according to claim 1, wherein the isolating process of the pH adjusted cross linked nano composite carbohydrate graft copolymer involves using a liquid desiccant and then performing an air drying process to obtain a dried bulk composite.

14. The method according to claim 1, wherein the liquid desiccant is selected from a group comprising methanol, ethanol, propanol and isopropanol and combination thereof.

15. A method of improving the agricultural productivity using a nano-composite superabsorbent polymer (NC-SAP) encapsulating nutrients, the method comprising: applying a NC-SAP to a soil, an agricultural plant, the seeds of an agricultural plant, and to a seedling.

16. The method of improving the agricultural productivity according to claim 16, wherein the nano-composite superabsorbent polymer encapsulating nutrients is directly applied to the soil.

17. The method of improving the agricultural productivity according to claim 16, wherein said nano-composite superabsorbent polymer encapsulating nutrients is coated on the seeds and the roots of the agricultural plant.

18. The method of improving the agricultural productivity according to claim 16, wherein said nano-composite superabsorbent polymer encapsulating nutrients is mixed with water to form a slurry.

19. The method of improving the agricultural productivity according to claim 16, wherein said slurry is applied to a plant, a root, the seeds, a seedling, or directly to soil into which one of a plant, root, seed, or seedling is planted.
